(19) United States
(12) Patent Application Publication
(10) Pub. No.: US 2024/0121837 A1
(43) Pub. Date: Apr. 11, 2024

(54) MR-DC IMPROVEMENTS

(71) Applicant: QUALCOMM Incorporated, San Diego, CA (US)

(72) Inventors: Hong CHENG, Basking Ridge, NJ (US); Shailesh PATIL, San Diego, CA (US); Ozcan OZTURK, San Diego, CA (US); Gavin Bernard HORN, La Jolla, CA (US); Peng CHENG, Beijing (CN); Karthika PALADUGU, Hyderabad (IN)

(21) Appl. No.: 18/276,877

(22) PCT Filed: Apr. 9, 2021
(86) PCT No.: PCT/CN2021/086182

§ 371 Date: Aug. 10, 2023

(51) Int. Cl. H04W 76/14; H04W 48/20; H04W 76/20

(52) U.S. Cl. CPC H04W 76/14; H04W 48/20; H04W 76/20; H04W 80/02

(57) ABSTRACT

Apparatus, methods, and computer program products for disaggregated UE are provided. An example method includes establishing a connection session with the second UE. The example method further includes transmitting a request for establishing a direct radio resource control (RRC) connection with the radio access network via the connection session. The example method further includes configuring a radio bearer of the second UE.

### INTRODUCTION

The present disclosure relates generally to communication systems, and more particularly, to wireless communication systems with multiple radio access technology (multi-RAT).

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method is provided at a first user equipment (UE) connected to a radio access network via a second UE. The method may include establishing a connection session with the second UE. The method may further include establishing a direct radio resource control (RRC) connection with the radio access network via the connection session. The method may further includes configuring a radio bearer of the second UE.

In another aspect of the disclosure, an apparatus is provided at a first UE configured to be connected to a radio access network via a second UE. The apparatus comprises a memory and at least one processor coupled to the memory, the memory and the at least one processor being configured to establish a connection session with the second UE. The memory and the at least one processor coupled to the memory may be further configured to establish a direct RRC connection with the radio access network via the connection session. The memory and the at least one processor coupled to the memory may be further configured to configure a radio bearer of the second UE.

In another aspect of the disclosure, an apparatus is provided at a first UE configured to be connected to a radio access network via a second UE. The apparatus may include means for establishing a connection session with the second UE. The apparatus may further include means for establishing a direct RRC connection with the radio access network via the connection session. The apparatus may further include means for configuring a radio bearer of the second UE.

In another aspect of the disclosure, a computer-readable storage medium is provided at a first UE configured to be connected to a radio access network via a second UE. The computer-readable storage medium may store computer executable code, the code when executed by a processor may cause the processor to establish a connection session with the second UE. The code when executed by a processor may further cause the processor to establish a direct RRC connection with the radio access network via the connection session. The code when executed by a processor may further cause the processor to configure a radio bearer of the second UE.

In another aspect of the disclosure, a method provides a connection for a first UE configured to be connected to a radio access network via a second UE. The method may include establishing a connection session with the first UE. The method may further include providing, to the first UE, a direct RRC connection with the radio access network via the connection session. The method may further include receiving a configuration of a radio bearer of the second UE from the first UE.

In another aspect of the disclosure, an apparatus provides a connection for a first UE configured to be connected to a radio access network via a second UE. The apparatus comprises a memory and at least one processor coupled to the memory, the memory and the at least one processor being configured to establish a connection session with the first UE. The memory and the at least one processor coupled to the memory may be further configured to provide, to the first UE, a direct RRC connection with the radio access network via the connection session. The memory and the at least one processor coupled to the memory may be further configured receive a configuration of a radio bearer of the second UE from the first UE.

In another aspect of the disclosure, an apparatus provides a connection of a first UE configured to be connected to a radio access network via a second UE. The apparatus may include means for establishing a connection session with the first UE. The apparatus may further include means for providing, to the first UE, a direct RRC connection with the radio access network via the connection session. The apparatus may further include means for receiving a configuration of a radio bearer of the second UE from the first UE.

In another aspect of the disclosure, a computer-readable storage medium is provided at a first UE that provides a connection of the first UE configured to be connected to a radio access network via a second UE. The computer-readable storage medium may store computer executable code, the code when executed by a processor may cause the processor to establish a connection session with the first UE. The code when executed by a processor may further cause the processor to provide, to the first UE, a direct RRC connection with the radio access network via the connection session. The code when executed by a processor may further cause the processor to receive a configuration of a radio bearer of the second UE from the first UE.

In another aspect of the disclosure, a method is provided at a network. The method may comprise establishing a first connection with a first UE. The method may further comprise establishing a direct RRC connection with the first UE via a second UE. The method may further include receiving a configuration of a radio bearer of the second UE from the first UE.

In another aspect of the disclosure, an apparatus is provided at a network. The apparatus comprises a memory and at least one processor coupled to the memory and configured to establish a first connection with a first UE. The memory and the at least one processor coupled to the memory may be further configured to establish a direct RRC connection with the first UE via a second UE. The memory and the at least one processor coupled to the memory may be further configured to receive a configuration of a radio bearer of the second UE from the first UE.

In another aspect of the disclosure, an apparatus is provided at a network. The apparatus may include means for establishing a first connection with a first UE. The apparatus may further include means for establishing a direct RRC connection with the first UE via a second UE. The apparatus may further include means for receiving a configuration of a radio bearer of the second UE from the first UE.

In another aspect of the disclosure, a computer-readable storage medium is provided at a network. The computer-readable storage medium may store computer executable code, the code when executed by a processor may cause the processor to establish a first connection with a first UE. The code when executed by a processor may further cause the processor to establish a direct RRC connection with the first UE via a second UE. The code when executed by a processor may further cause the processor to receive a configuration of a radio bearer of the second UE from the first UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example communication system.

FIG. 5 is a diagram illustrating an example multi-RAT dual connectivity (MR-DC) framework.

FIG. 6A-6D are diagrams illustrating examples of UE and access network architectures for MR-DC.

FIG. 7 is a diagram illustrating example communications between two UEs and a base station.

FIG. 8 is a flowchart of a method of wireless communication.

FIG. 9 is a diagram illustrating an example of a hardware implementation for an example apparatus.

FIG. 10 is a flowchart of a method of wireless communication.

FIG. 11 is a diagram illustrating an example of a hardware implementation for an example apparatus.

FIG. 12 is a flowchart of a method of wireless communication.

FIG. 13 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable storage medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

Some UEs in a wireless communication system, such as vehicle UEs, may be equipped with better radio frequency (RF) performance antennas compared to other UEs including smaller UEs such as a phone. In addition, the placement of the antenna on the vehicle may result in better RF performance. For example, vehicle RF antenna may be outside of the vehicle and not subject to the shielding of the vehicle body and window and may be on the roof of the vehicle which may result in having a clear line of sight with the base station. However, a vehicle may potentially have an older model modem compared to the other UEs. The smaller UE, such as a mobile phone or other device, may have a shorter replacement cycle than a vehicle and may include newer and more advanced baseband units and modems than the vehicle in some aspects, e.g. supporting more carriers and new coding schemes. However, vehicle UEs may still experience better network connectivity, with one or more external RF antennas.

Some aspects provided herein provide a multi-radio dual connectivity (MR-DC) framework that may enable a vehicle UE and a non-vehicle UE to be considered to be a disaggregated UE, i.e., collectively considered to be one control plane entity to a core network. A disaggregated UE (which may also be referred to as a “DUE”) may refer to a set of UEs that are collectively considered to be one control plane entity to a core network. As one non-limiting example, a phone UE may control the RRC modules of a vehicle UE by establishing a connection session with the vehicle UE. A connection session may refer to a connection independent of a core network between two UEs. The vehicle UE may support a controlee mode and may transparently forward (forwarding without decoding) RRC messages to the UE via the connection session. The UE may configure the vehicle UE with RRC configurations via the connection session. The UE may communicate with the radio access network via the vehicle UE's antenna.

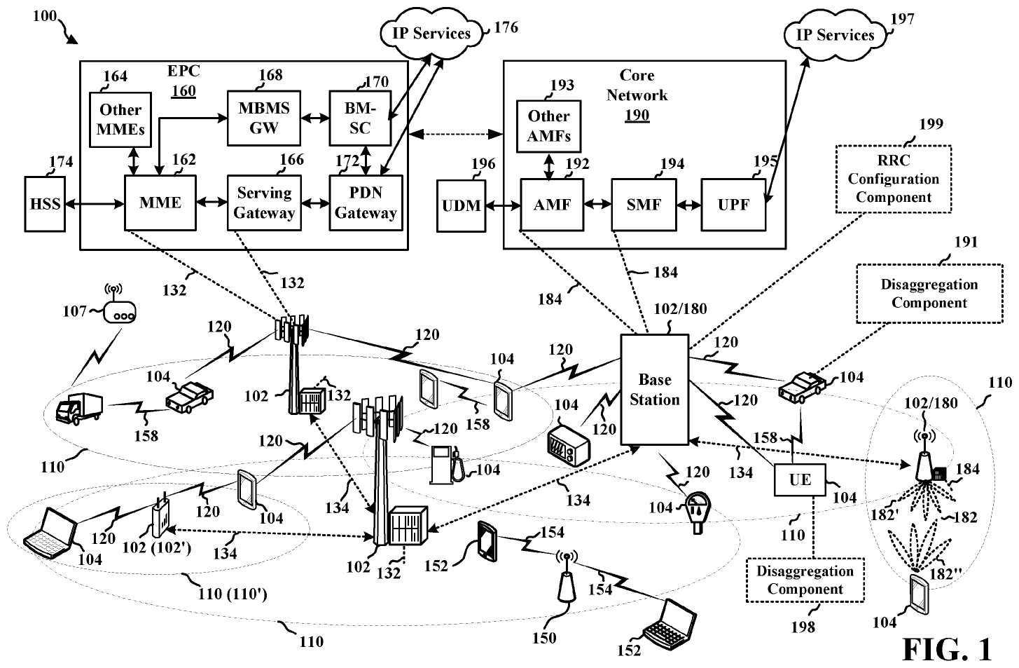

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). A UE 104 may also communicate with a road-side-unit 107.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a disaggregation component 198. In some aspects, the disaggregation component 198 may be configured to establish a connection session with the second UE. In some aspects, the disaggregation component 198 may be further configured to establish a direct RRC connection with the radio access network via the connection session. In some aspects, the disaggregation component 198 may be further configured to configure a radio bearer of the second UE.

In some aspects, the UE 104 (e.g., which may be a vehicle UE or a UE associated with a vehicle) may include the disaggregation component 191 that is configured to establish a connection session with the first UE (which may be a non-vehicle UE). In some aspects, the disaggregation component 191 may be further configured to provide, to the first UE, a direct RRC connection with the radio access network via the connection session. In some aspects, the disaggregation component 191 may be further configured to receive a configuration of a radio bearer of the second UE from the first UE.

In some aspects, the base station 102/180 may include an RRC configuration component 199 configured to establish a first connection with a first UE. In some aspects, the RRC Configuration component 199 may be further configured to transmit, to the first UE, an RRC configuration to support at least a first PDU session and a second PDU session between the first UE and the second UE based on the UE capability indication.

Although the following description may be focused on SGNR, the concepts described herein may be applicable to other similar areas, such as LTE, LTE-A, CDMA, GSM, and other wireless technologies.

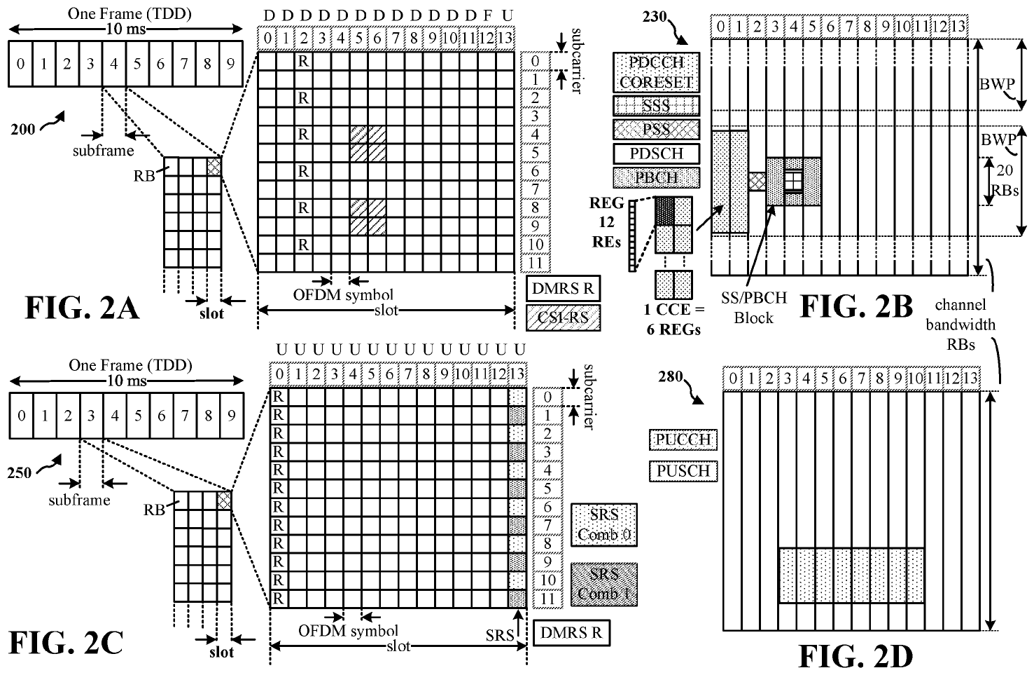

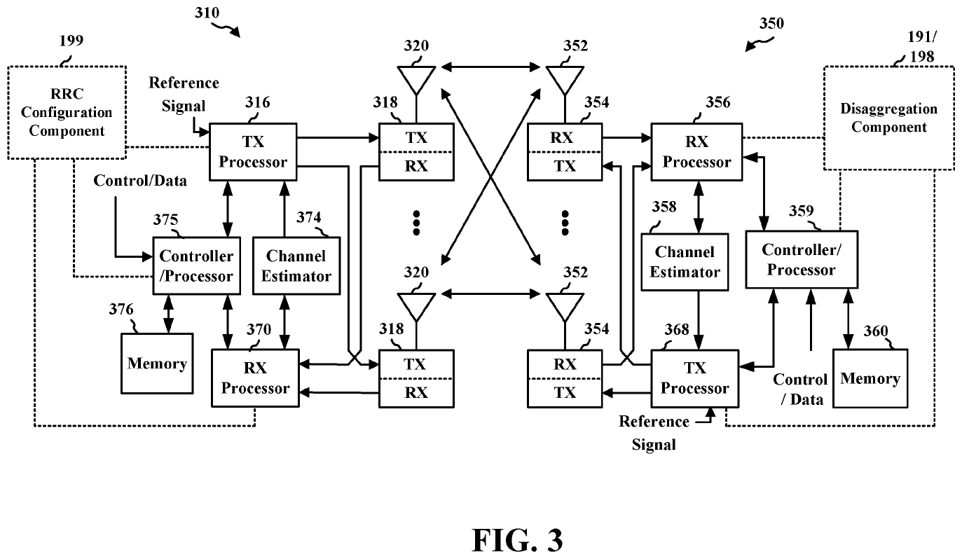

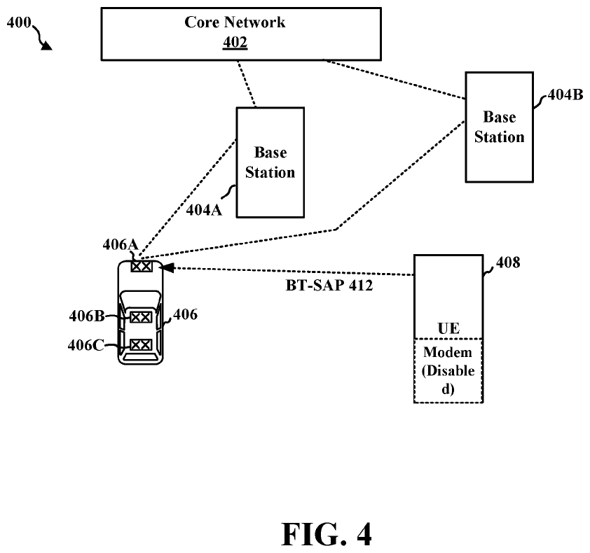

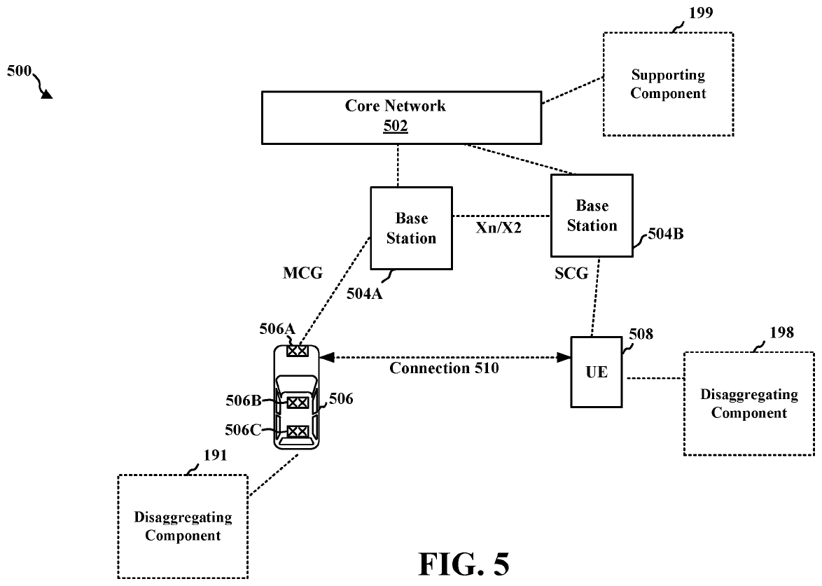

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) information (ACK/negative ACK (NACK)) feedback. The PUSCH carries data, and may additionally be used to carry a buffer status report (BSR), a power headroom report (PHR), and/or UCI.

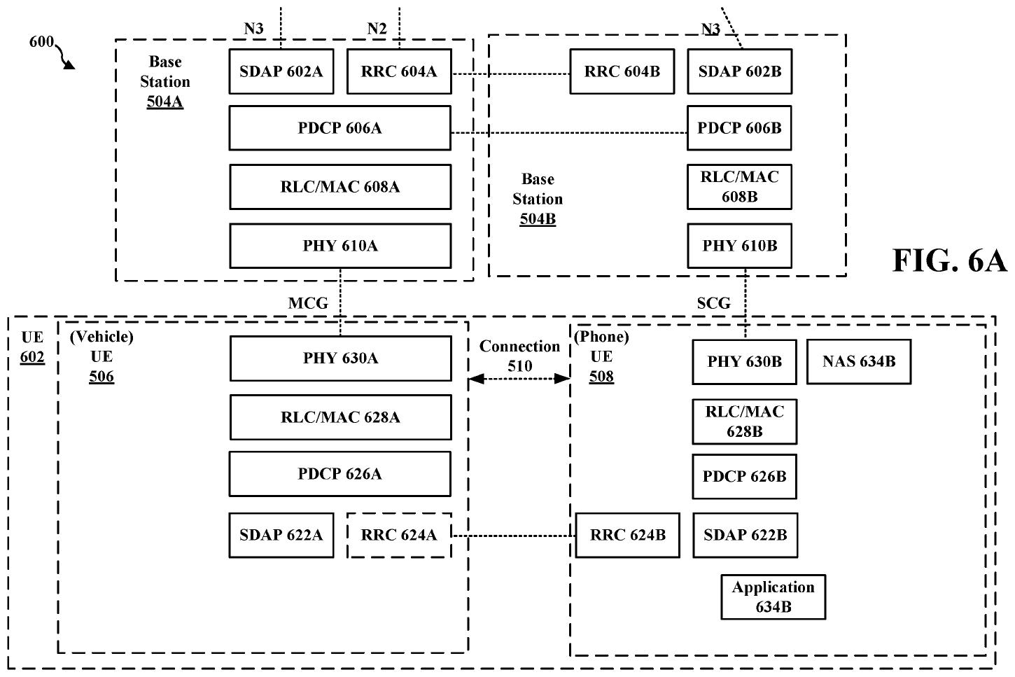

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable storage medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable storage medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the disaggregation component 191/198 of FIG. 1.

At least one of the TX processor 316, the RX processor 370, and the controller/processor 375 may be configured to perform aspects in connection with the RRC configuration component 199 of FIG. 1.

Some UEs in a wireless communication system, such as vehicle UEs, may be equipped with better radio frequency (RF) performance antennas compared to other UEs including smaller UEs such as a phone, due to the location of the antennas. However, a vehicle may potentially have an older model modem compared to the other UEs. The smaller UE, such as a mobile phone or other device, may have a shorter replacement cycle than a vehicle and may include newer and more advanced baseband units and modems that can handle more carriers or different coding schemes than the vehicle in some aspects. However, vehicle UEs may still experience better network performance due to better network connectivity, such as with one or more external RF antennas. In some aspects, an RF antenna may be external to the vehicle. The antenna(s) may experience improved RF performance comparing to the UEs inside the vehicle, e.g., due to the metal content of the vehicle or other aspects.

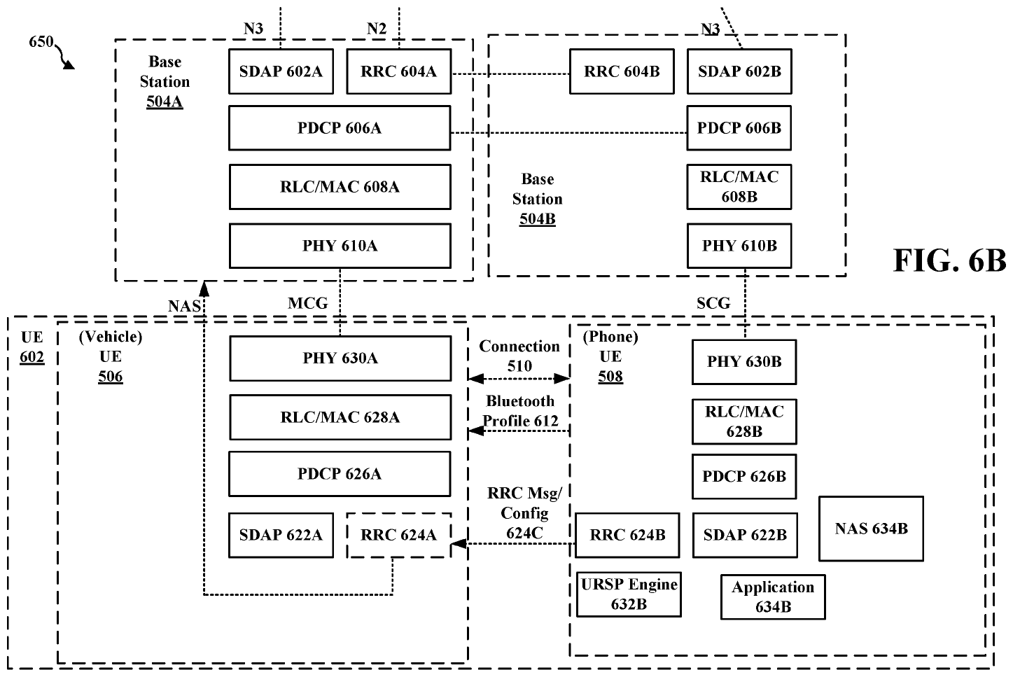

Aspects presented herein provide a communication system that may allow a mobile phone UE to take advantage of the better antenna performance of a vehicle by allowing user subscriber identification module (SIM) sharing via a Bluetooth SIM access profile (BT-SAP) connection session. For example, in example 400 illustrated in FIG. 4, a UE 408 (e.g., a non-vehicle UE, a smaller UE, etc.) may be connected to a vehicle UE 406 via BT-SAP 412 and may have the UE's 408 modem disabled. The UE 408 may communicate with the base station 404B (which in turn exchanges communication with the core network 402) via one or more antennas 410 and a modem of the vehicle UE 408. Under such user SIM sharing, the phone UE may access data via the modem of the vehicle UE 406 and one or more antennas 406A, 406B, and 406C of the vehicle UE 406. The UE 406 may communicate with the base station 404A. In some aspects, the UE 408 may have a modem that supports more carriers, or for example mmW access, more frequency bands, etc. compared to the vehicle UE 406. In some aspects, a vehicle module may support multiple modems operating simultaneously (e.g., overlapping in time) for data access. A modem may be used for telematics for the vehicle, and another may be used for user data, e.g., including information and entertainment delivery.

Some aspects provided here in provide a MR-DC framework that may allow a UE to control the RRC modules of a vehicle UE. The UE may communicate with the radio access network via the vehicle UE's antenna system. The vehicle UE may support a controlee mode and may transparently forward (forwarding without decoding) RRC messages to and from the UE. Additionally, the UE may also configure and control the vehicle UE with RRC configurations.

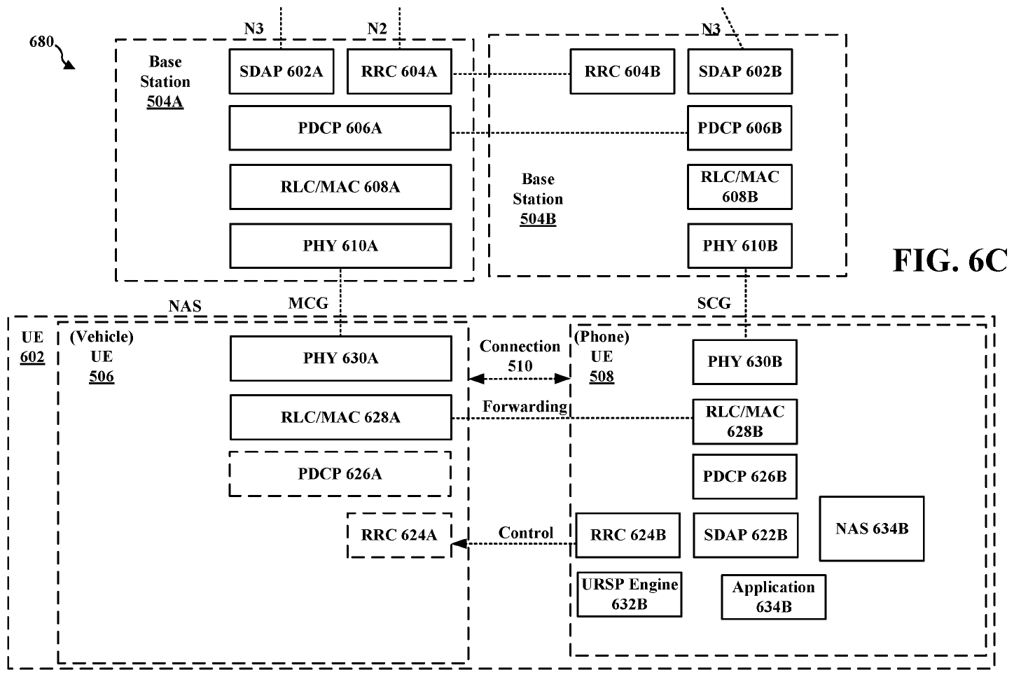

As illustrated in example 500 illustrated in FIG. 5, the core network 502 may be connected to one or more base stations 504A and 504B. The base station 504A may be associated with the RRC configuration component 199 and may be connected to a vehicle UE 506 (which may be equipped with the disaggregation component 191). The base station 504B may be connected to a UE 508 (e.g., a non-vehicle UE, such as a phone or other UE) which may be equipped with the disaggregation component 198. The vehicle UE 506 may include one or more antennas 506A, 506B, and 506C. The mobile phone UE 508 may be connected to the base station 504B via a secondary cell group (SCG) and the vehicle UE 506 may be connected to the base station 504A via a master cell group (MCG). The mobile phone UE 508 and the vehicle UE 506 may be connected with each other via a connection 510. The connection 510 may be a Bluetooth connection session or a Wi-Fi/wireless local area network (WLAN) connection session. In some aspects, the simultaneous access from the vehicle UE 506 and the UE 508 may enable the SCG to be configured for the UE 508 yet may lead the core network 502 to view the UEs 506 and 508 as one control entity. Aspects presented herein enable coordination between the vehicle UE 506 and the UE 508 to provide a disaggregated UE for MR-DC. In some aspects, the UE 508 may control RRC components/modules of the vehicle UE 506. In some aspects, the vehicle UE 506 may transparently forward (forwarding without decoding) RRC messages to and from the UE 508. In some aspects, the vehicle UE 506 may also transparently forward RRC messages received from the UE 508 to base station 504A. There may be also Non-Access Stratum (NAS) messages embedded in the RRC messages, which will be forwarded by the base station 504A to the core network 502. In some aspects, the vehicle UE 506 may allow RRC operations based on configurations received from the UE 508. The RRC operations include for example setting up a signaling radio bearer (SRB) with the base station 504A, and may also include the setting up of one or more data radio bearers (DRBs). In some aspects, there is no need for a BT-SAP profile sharing between the vehicle UE 506 and the UE 508 and the SIM information may stay on the UE 508. The vehicle UE 506 may be configured, via the connection 510, to allow remotely controlled RRC operations that may be based on the SIM information. In some aspects, the UE 508 may control a public mobile land network (PLMN) selection or a cell selection of the vehicle UE 506. This can be achieved by providing a set of filtering criteria to the vehicle UE 506 via the connection 510, and receiving a list of PLMN information and/or cell information from the vehicle UE 506. This may include the additional information about the access barring of the cells. The UE 508 may perform the cell and PLMN selection based on its SIM information and location configuration. The UE 508 may instruct the vehicle UE 506 on the cell to connect to, e.g. by providing the selected cell ID. In some aspects, the vehicle UE 506 may then synchronize with the indicated cell and camp on it.

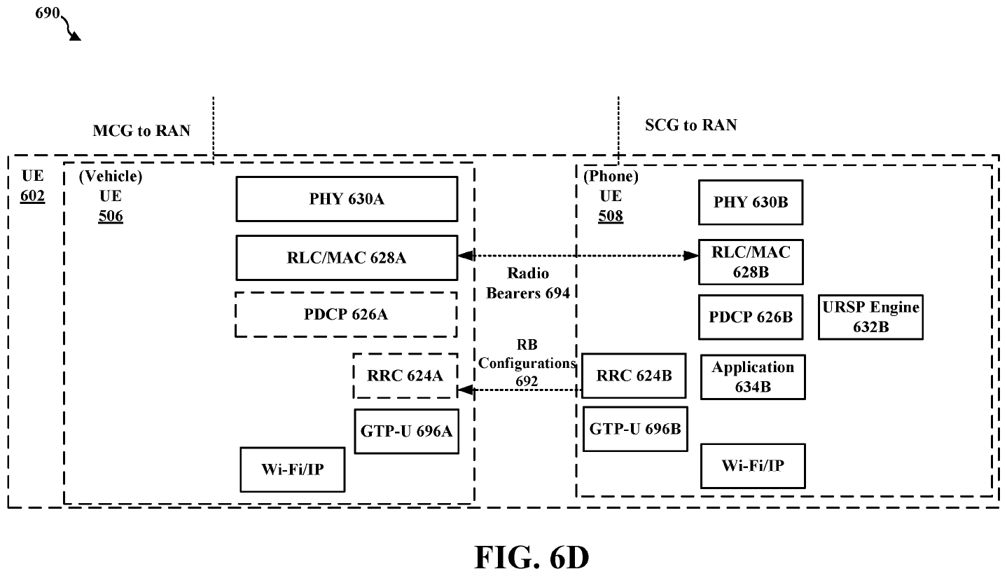

As illustrated in example 600 in FIG. 6A, the base station 504A may include a service data adaptation protocol (SDAP) component 602A, a radio resource control (RRC) component 604A, a packet data convergence protocol (PDCP) component 606A, a radio link control (RLC)/medium access control (MAC) component 608A, and a physical layer (PHY) component 610A. The base station 504B may include a SDAP component 602B, an RRC component 604B, a PDCP component 606B, an RLC/MAC component 608B, and a PHY component 610B. The base station 504A may communicate with the core network via N3 (control) and N2 (user plane) and the base station 504B may communicate with the core network via N3. The PHY component 610A of the base station 504A may communicate with the PHY component 630A of the vehicle UE 506. The PHY component 610B of the base station 504B may communicate with the PHY component 630B of the mobile phone UE 508. The vehicle UE 506 and the mobile phone UE 508 may be considered collectively as a disaggregated UE 602. A disaggregated UE may refer to a set of UEs that are collectively considered to be one control plane entity to a core network.

The UE 508 may further include an RLC/MAC component 628A, a PDCP component 626A, a SDAP component 622A, an RRC component 624A, and a non-access stratum (NAS) component. The UE 508 may further include an RLC/MAC component 628B, a PDCP component 626B, a SDAP component 622B, an RRC component 624B, and an NAS component 634B. In some aspects, the UE 508 and the UE 508 may be considered to be one control plane entity to the core network 502. The NAS component and the RRC component 624A may be used, for controlling both the UE 508 and vehicle UE 506. In some aspects, the RRC component 624B may not directly communicate with the base station/the core network and may control the RRC component 624A. For example, the RRC component 624B may transmit an RRC message to the RRC component 624A and the RRC component 624A may transparently forward the RRC message to the base station 504A. In some aspects, the RRC component 624A of the vehicle UE 506 may support a controlee mode that results remote control by the RRC component 624B of the UE 508.

In some aspects, as illustrated in example 650 of FIG. 6B, the vehicle UE 506 may be configured with a profile 612 that to allow remotely controlled RRC operation (for example, to allow the RRC component 624A of the vehicle UE 506 to be controlled by the RRC component 624B of the UE 508). In some aspects, the profile 612 may be a Bluetooth profile (such as a BT-SAP profile). In some aspects, the profile 612 may be a Wi-Fi profile. In some aspects, by being configured with the profile 612, the UE 508 may control a PLMN selection or a cell selection of the vehicle UE 506. In some aspects, the UE 508 may further include a UE route selection policy (URSP) engine 632B. In some aspects, the UE 508, such as the RRC component 624B of the UE 508, may generate RRC messages or configurations 624C to be transparently forwarded by the vehicle UE 506 to the base station 504B and the core network. In some aspects, the UE 508 may perform handover based on a registration request. For example, the UE 508 may transmit a registration request to the vehicle UE 506. In some aspect, the UE 508 may instruct the vehicle UE 506 for a measurement report. The UE 508 may provide the received measurement report from vehicle UE 506 to UE 508's serving cell, which triggers a handover operation. The UE 508 may complete the handover by sending a handover complete message, e.g., which may be referred to as a “RRCReconfigureComplete message”, to the base station 504A. In some aspects, the RRC messages or configurations 624C are encapsulated in the RRC layer of the UE 508, such as the RRC component 624B, and transferred over the PDCP component 626A of the vehicle UE 506. In some aspects, the RRC messages or configurations 624C are encapsulated by PDCP layer of the UE 508, such as the PDCP component 626B, and carried by the RLC layer of the vehicle UE 506, such as the RLC/MAC component 628A to the core network. In some aspects, the RRC messages or configurations 624C are encapsulated by RLC layer of the UE 508, such as the RLC/MAC component 628B, and carried by the MAC layer of the vehicle UE 506, such as the RLC/MAC component 628A, to the core network. In some aspects, the RRC messages or configurations 624C are encapsulated by MAC layer of the UE 508, such as the RLC/MAC component 628B, and carried by PHY layer, such as the PHY component 630A of the vehicle UE 506 to the core network.

In some aspects, as illustrated in example 680 of FIG. 6C and example 690 of FIG. 6D, the vehicle UE's 506 PHY component 630A and the RLC/MAC component 628A are used and the PDCP component 626A may be disabled. The RRC component 624A may be controlled by the RRC component 624B of the UE 508. The UE 508 may configure, by controlling the RRC component 624A via the RRC component 624B of the UE 508, one or more radio bearers 694 of the vehicle UE 506. The UE 508 may exchange radio bearer configurations 692 with the vehicle UE 506.

In some aspects, as illustrated in example 690 of FIG. 6D, the PHY component 630A, the RLC/MAC component 628A, and the RRC component 624A of the vehicle UE 506 are each under control of the UE 508. In some aspects, the PHY component 630A, the RLC/MAC component 628A, and the RRC component 624A of the vehicle UE 506 are all under control of the UE 508 via the RRC component 624B. In some aspects, the control signaling for the PHY component 630A, the RLC/MAC component 628A, and the RRC component 624A of the vehicle UE may be transmitted from the UE 508, such as the RRC component 624B of the UE 508. In some aspects, all the components of the vehicle UE 506, e.g. PDCP component 626A, RLC/MAC component 628A, PHY component 630A, are active and under the control of UE 508's RRC component 624B, in order to serve certain radio bearers established by the RRC component 624B with the radio access network 504A. For example, the UE 508 may establish one or more PDU sessions, with some radio bearers terminated on UE 508, and other radio bearers terminated on UE 506. In that case, RRC component 624B may instruct via the RRC component 624A for the establishment of the radio bearers terminated on UE 506, including providing configurations for components of 626A, 628A, and 630A. In some aspects, the control signaling or data packets of a radio bearer are transmitted via a connection that may be established using Internet Protocol (IP) over a Wi-Fi link using general packet radio service (GPRS) tunneling protocol-user (GTP-U) components 696A and 696B. GTP-U may be a link that carries user data in the form of IPv4, IPv6, or point-to-point protocol (PPP) packets. In some aspects, one or more exchange for RRC information exchange may be transmitted from a channel separate from the link between the GTP-U components 696A and 696B, such as the connection 510. In some aspects, the vehicle UE 506 and the UE 508 may support MAC/PHY disaggregation. For example, the PHY layer, MAC layer, RLC layer, RRC layer, or PDCP/SDAP of a same virtual entity (the UE 602) may be physically located on different devices (the vehicle UE 506 and the UE 508). In one example, the MAC/PHY disaggregation may be based on a split interface based on open radio access network (O-RAN) split interface option 6 MAC-PHY split, option 7 including 7-1, 7-2/7-2x, 7-3, or 7-4 for PHY split, or option 8 for PHY split.

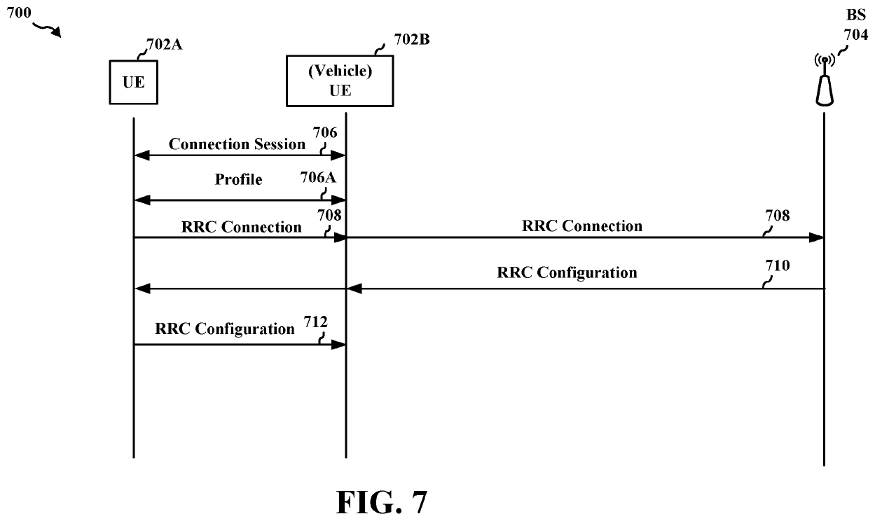

FIG. 7 is a diagram 700 illustrating example communication between two UEs 702A and 702B and a base station 704. In some aspects, the UE 702B may be a vehicle UE, such as the vehicle UE 506. In some aspects, the UE 702A may be a mobile phone UE, such as the mobile phone UE 508. In some aspects, the UE 702A establishes a connection session 706 with the UE 702B. In some aspects, the connection session 706 may include a Bluetooth session. In some aspects, the connection session 706 may include a WLAN session. In some aspects, the connection session 706 may include an IP session over GTP-U. In some aspects, to establish the connection session 706, the UE 702A may transmit a profile 706A to the UE 702B. In some aspects, the connection session results the UE 702A to remotely control RRC modules of the UE 702B.

In some aspects, the UE 702A may establish RRC connection 708 with the UE 702B. In some aspects, the RRC connection 708 is configured to be encapsulated in the RRC layer of the UE 702A, and transferred over the Packet Data Convergence Protocol (PDCP) component of the UE 702B. In some aspects, the RRC connection 708 is encapsulated by PDCP layer of the UE 702A and carried by the RLC layer of the UE 702B to the base station 704. In some aspects, the RRC connection 708 is encapsulated by RLC layer of the UE 702A and carried by the MAC layer of the UE 702B to the base station 704. In some aspects, the RRC connection 708 is encapsulated by MAC layer of the UE 702A and carried by PHY layer of the UE 702B to the base station 704. In some aspects, the base station 704 may transmit an RRC configuration 710 to the UE 702A. The RRC configuration 710 may be transmitted to the UE 702A via transparent forwarding by the UE 702B. In some aspects, the UE 702A may transmit an RRC configuration 712 to the UE 702B to control the UE 702B. This configuration 712 may indicate, for example, on which of the encapsulation option described above to be use for the other radio bearers established by the RRC configuration 710. In some aspects, the RRC connection 708 and RRC Configuration 710 involves multiple RRC level signaling messages, e.g. RRCSetupRequest, RRCSetup, RRCSetupComplete, RRCReconfiguration, and/or RRCReconfigurationComplete.

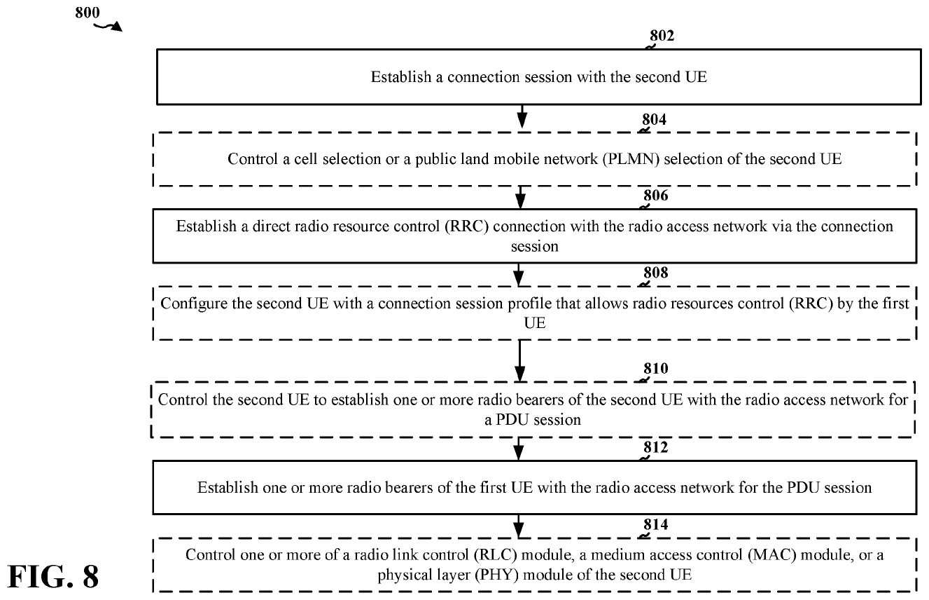

FIG. 8 is a flowchart 800 of a method of wireless communication. The method may be performed by a first UE (for example, the UE 104, the UE 508, the UE 702A; the apparatus 902). Optional steps are illustrated in dashed lines. The steps are not necessarily illustrated in chronological order. The method may be performed by the first UE to connect to a radio access network via a second UE (for example, the UE 104, the UE 508, the UE 702B; the apparatus 1102). In some aspects, the second UE may be a vehicle UE and the first UE may be a non-vehicle UE, such as illustrated in the examples in FIGS. 4 and/or 5. In some aspects, the first UE may be a phone. In some aspects, the first UE is connected to the radio access network via a first set of SRBs and the second UE is connected to the radio access network via a second set of SRBs, the first set of SRBs being different from the second set of SRBs.

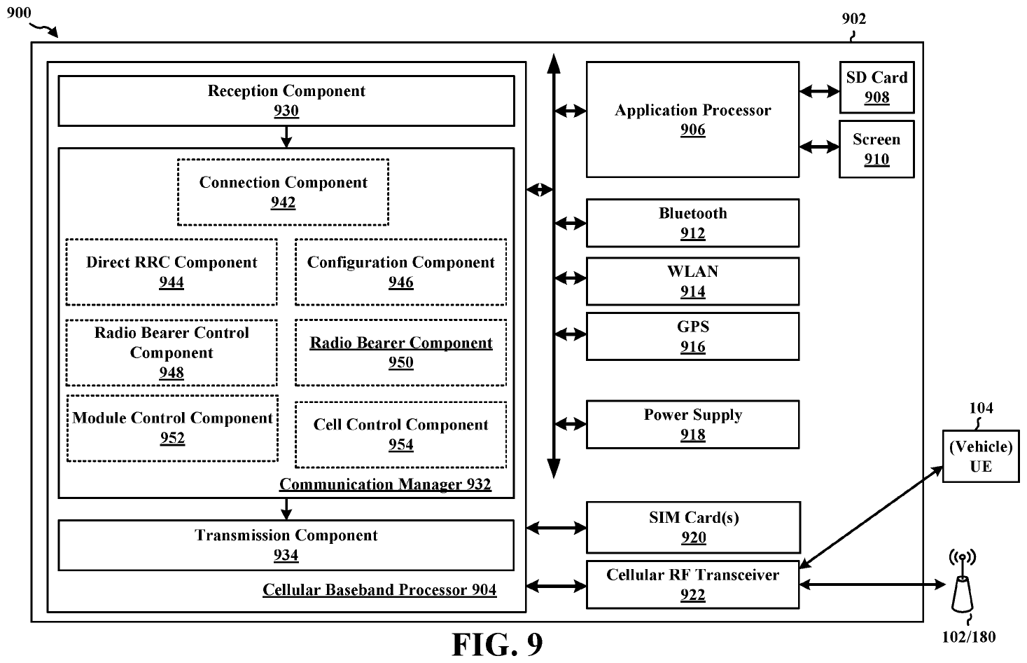

At 802, the UE may establish a connection session with the second UE. In some aspects, 802 may be performed by connection component 942 in FIG. 9. In some aspects, the connection session comprises a BT-SAP session. In some aspects, the connection session comprises a WLAN session. In some aspects, the connection session corresponds with the connection 510 in FIG. 5 and FIGS. 6A-6D. In some aspects, the connection session corresponds with the connection session 706 in FIG. 7. In some aspects, establishing a connection session with the second UE comprises transmitting a UE radio capability information. In some aspects, the UE radio capability information further indicates the support for a simultaneous connection of the first UE and the second UE to the radio access network. In some aspects, the first UE supports a first data rate and the second UE supports a second data rate, the first data rate being different from the second data rate. In some aspects, a connection between the first UE and the second UE provides a lower layer MAC and PHY disaggregation.

At 804, the UE may control a cell (re)selection or a PLMN (re)selection of the second UE. In some aspects, 804 may be performed by a cell control component 954 in FIG. 9. In some aspects, the UE may control a cell (re)selection or a PLMN (re)selection of the second UE by controlling RRC module/component of the second UE. In some aspects, the first UE may receive RRC messages originated from the radio access network and transparently forwarded by the second UE. In some aspects, in order to control the cell (re)selection or PLMN (re)selection of the second UE, the UE obtains from the second UE the current cell information, e.g. list of suitable cells, PLMN ID lists, Tracking Area ID list, Access Class Barring (ACB) information, or other system level information announced by the cell and received by the second UE.

At 806, the UE may establish a direct RRC connection with the radio access network via the connection session. In some aspects, 806 may be performed by direct RRC component 944 in FIG. 9. In some aspects, the direct RRC connection may correspond with the RRC connection 708 in FIG. 7. In some aspects, as part of establishing the direct RRC connection, the UE may transmit a registration request to the second UE.

At 808, the UE may configure the second UE with a connection session profile that results RRC by the first UE. In some aspects, 808 may be performed by configuration component 946 in FIG. 9. In some aspects, as part of the configuration, the UE may receive a capability indication for the second UE from the second UE.

At 810, the UE may control the second UE to establish one or more radio bearers of the second UE with the radio access network for a PDU session. In some aspects, 810 may be performed by Radio bearer control component 948 in FIG. 9. At 812, the UE may establish one or more radio bearers of the first UE with the radio access network for the PDU session. In some aspects, 812 may be performed by the radio bearer component 950 in FIG. 9.

At 814, the UE may control one or more of an RLC (module), a MAC (module), or a PHY (module) of the second UE. In some aspects, 814 may be performed by the module control component 952 in FIG. 9. In some aspects, the direct RRC connection is configured to be encapsulated in an RRC layer of the first UE and transferred over a PDCP component of the second UE. In some aspects, the direct RRC connection is configured to be encapsulated by PDCP layer of first UE, and carried by the RLC layer module of second UE to the RAN. In some aspects, the direct RRC connection is configured to be encapsulated by RLC layer of the first UE, and carried by the MAC layer module of the second UE to the RAN. In some aspects, the direct RRC connection is configured to be encapsulated by MAC layer of first UE, and carried by PHY layer module of the second UE to the RAN.

FIG. 9 is a diagram 900 illustrating an example of a hardware implementation for an apparatus 902. The apparatus 902 may be a UE and includes a cellular baseband processor 904 (also referred to as a modem) coupled to a cellular RF transceiver 922 and one or more subscriber identity modules (SIM) cards 920. The apparatus may further include any of an application processor 906 coupled to a secure digital (SD) card 908 and a screen 910, a Bluetooth module 912, a wireless local area network (WLAN) module 914, a Global Positioning System (GPS) module 916, or a power supply 918. The cellular baseband processor 904 communicates through the cellular RF transceiver 922 with the UE 104 (which may be a vehicle UE) and/or the base station 102/180. The cellular baseband processor 904 may include a computer-readable storage medium/memory. The computer-readable storage medium/memory may be non-transitory. The cellular baseband processor 904 is responsible for general processing, including the execution of software stored on the computer-readable storage medium/memory. The software, when executed by the cellular baseband processor 904, causes the cellular baseband processor 904 to perform the various functions described supra. The computer-readable storage medium/memory may also be used for storing data that is manipulated by the cellular baseband processor 904 when executing software. The cellular baseband processor 904 further includes a reception component 930, a communication manager 932, and a transmission component 934. The communication manager 932 includes the one or more illustrated components. The components within the communication manager 932 may be stored in the computer-readable storage medium/memory and/or configured as hardware within the cellular baseband processor 904. The cellular baseband processor 904 may be a component of the UE 350 and may include the memory 360 and/or at least one of the TX processor 368, the RX processor 356, and the controller/processor 359. In one configuration, the apparatus 902 may be a modem chip and include just the baseband processor 904, and in another configuration, the apparatus 902 may be the entire UE (e.g., see 350 of FIG. 3) and include the additional modules of the apparatus 902.

The communication manager 932 may include a connection component 942 that is configured to establish a connection session with the second UE, e.g., as described in connection with 802 in FIG. 8. The communication manager 932 may further include a direct RRC component 944 that is configured to establish a direct RRC connection with the radio access network via the connection session, e.g., as described in connection with 806 in FIG. 8. The communication manager 932 may further include a configuration component 946 that is configured to configure the second UE with a connection session profile that allows RRC by the first UE, e.g., as described in connection with 808 in FIG. 8. The communication manager 932 may further include a Radio bearer control component 948 that is configured to control the second UE to establish one or more radio bearers of the second UE with the radio access network for a PDU session, e.g., as described in connection with 810 in FIG. 8. The communication manager 932 may further include a radio bearer component 950 that is configured to establish one or more radio bearers of the first UE with the radio access network for the PDU session, e.g., as described in connection with 812 in FIG. 8. The communication manager 932 may further include a module control component 952 that is configured to control one or more of an RLC (module), a MAC (module), or a PHY (module) of the second UE, e.g., as described in connection with 814 in FIG. 8. The communication manager 932 may further include a cell control component 954 that is configured to control a cell selection or a PLMN selection of the second UE, e.g., as described in connection with 804 in FIG. 8.

The apparatus may include additional components that perform each of the blocks of the algorithm in the flowchart of FIG. 8 and/or the aspects performed by the UE. As such, each block in the flowchart of FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable storage medium for implementation by a processor, or some combination thereof.

In some aspects, the apparatus 902 may be a first UE that is configured to be connected to a radio access network via a second UE. In one configuration, the apparatus 902, and in particular the cellular baseband processor 904, includes means for establishing a connection session with the second UE, such as the cellular RF transceiver 922 or Bluetooth 911. The cellular baseband processor 904 may further include means for establishing a direct RRC connection with the radio access network via the connection session, such as the cellular RF transceiver 922 or Bluetooth 911. The cellular baseband processor 904 may further include means for configuring a radio bearer of the second UE directly, such as the cellular RF transceiver 922 or Bluetooth 911. The cellular baseband processor 904 may further include means for controlling the second UE to establish one or more radio bearers of the second UE with the radio access network for a PDU session, such as the cellular RF transceiver 922 or Bluetooth 911. The cellular baseband processor 904 may further include means for establishing one or more radio bearers of the first UE with the radio access network for the PDU session, such as the cellular RF transceiver 922 or Bluetooth 911. The cellular baseband processor 904 may further include means for controlling one or more of an RLC (module), a MAC (module), or a PHY (module) of the second UE, such as the cellular RF transceiver 922 or Bluetooth 911. The cellular baseband processor 904 may further include means for controlling a cell selection or a PLMN selection of the second UE, such as the cellular RF transceiver 922 or Bluetooth 911.

The means may be one or more of the components of the apparatus 902 configured to perform the functions recited by the means. As described supra, the apparatus 902 may include the TX Processor 368, the RX Processor 356, and the controller/processor 359. As such, in one configuration, the means may be the TX Processor 368, the RX Processor 356, and the controller/processor 359 configured to perform the functions recited by the means.

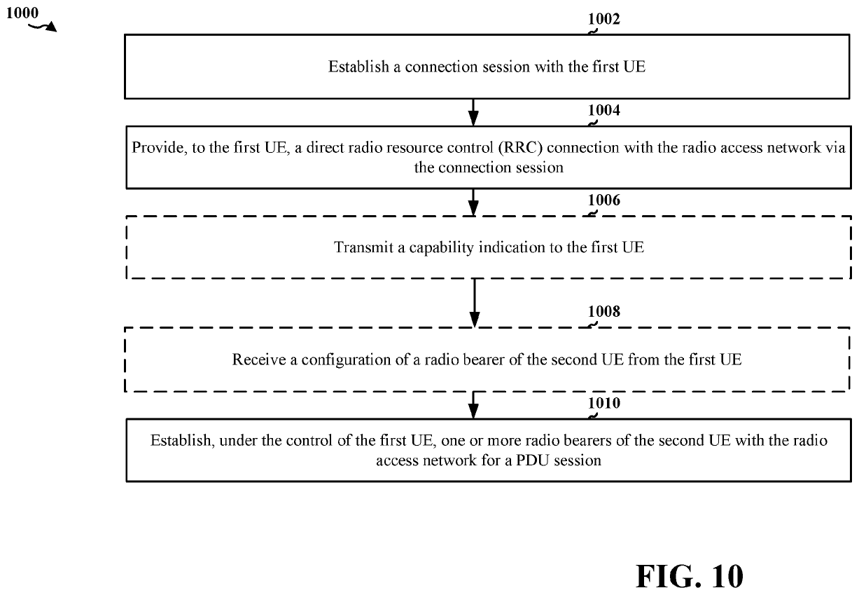

FIG. 10 is a flowchart 1000 of a method of wireless communication. The method may be performed by a second UE (for example, the UE 104, the UE 508, the UE 702B; the apparatus 1102). Optional steps are illustrated in dashed lines. The steps are not necessarily illustrated in chronological order. The method may be performed by the second UE to provide connection to a radio access network for a first UE (for example, the UE 104, the UE 508, the UE 702A; the apparatus 902). In some aspects, the second UE may be a vehicle UE, and the first UE may be a non-vehicle UE, such as illustrated in the examples in FIGS. 4 and/or 5. In some aspects, the first UE may be a phone.

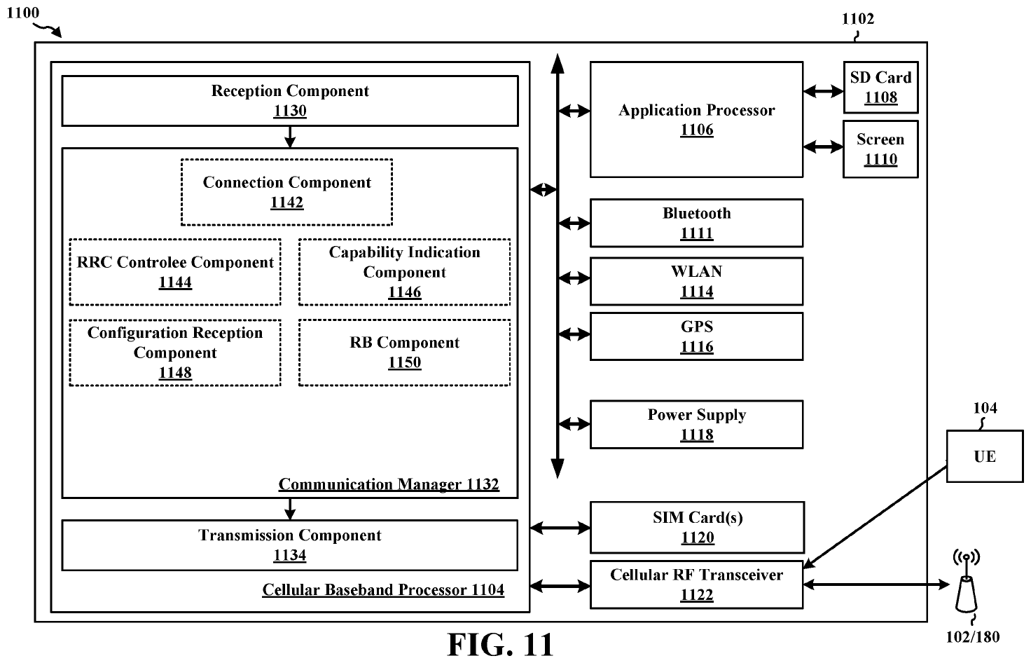

At 1002, the UE may establish a connection session with the first UE. In some aspects, 1002 may be performed by the connection component 1142 in FIG. 11. In some aspects, the connection session may be a Bluetooth session. In some aspects, the connection session comprises a WLAN session. In some aspects, the connection session corresponds with the connection 510 in FIG. 5 and FIGS. 6A-6D. In some aspects, establishing a connection session with the second UE comprises receiving a UE radio capability information. In some aspects, the UE radio capability information further indicates the support for a simultaneous connection of the first UE and the second UE to the radio access network. In some aspects, the first UE supports a first data rate and the second UE supports a second data rate, the first data rate being different from the second data rate. In some aspects, the second UE may be connected to the radio network via an MCG and the first UE may be connected to the radio network via a SCG.

At 1004, the UE may provide, to the first UE, a direct RRC connection with the radio access network via the connection session. In some aspects, 1004 may be performed by the RRC controlee component 1144 in FIG. 11. In some aspects, the direct RRC connection may correspond with the RRC connection 708 in FIG. 7. In some aspects, the direct RRC connection is configured to be encapsulated in an RRC layer of the first UE and transferred over a PDCP component of the second UE. In some aspects, the direct RRC connection is configured to be encapsulated by PDCP layer of first UE, and carried by the RLC layer module of second UE to the RAN. In some aspects, the direct RRC connection is configured to be encapsulated by RLC layer of the first UE, and carried by the MAC layer module of the second UE to the RAN. In some aspects, the direct RRC connection is configured to be encapsulated by MAC layer of first UE, and carried by PHY layer module of the second UE to the RAN. In some aspects, providing a direct RRC connection to the first UE further comprises receiving a registration request. For example, the UE may receive, from the first UE, a registration request in an NAS message.

In some aspects, the UE may forward an RRC message or an RRC configuration to the first UE. The forward may be transparent forward. In some aspects, the RRC configuration may correspond with the RRC configuration 710 in FIG. 7. In some aspects, the RRC configuration may correspond with the RRC configuration transmitted between RRC 624A and RRC 624B in FIGS. 6A-6D.

At 1006, the UE may transmit a capability indication for the UE to the first UE. In some aspects, 1006 may be performed by the capability indication component 1146 in FIG. 11. In some aspects, the capability indication may be part of a connection profile that enables the direct RRC connection.

At 1008, the UE may receive a configuration of a radio bearer of the second UE from the first UE. In some aspects, 1008 may be performed by the configuration reception component 1148 in FIG. 11. In some aspects, the configuration of a radio bearer of the second UE from the first UE may correspond with the RRC configuration 712.

At 1010, the UE may establish, under the control of the first UE (such as based on controlling signal from the first UE), one or more radio bearers of the second UE with the radio access network for a PDU session. In some aspects, 1010 may be performed by the RB component 1150 in FIG. 11.

FIG. 11 is a diagram 1100 illustrating an example of a hardware implementation for an apparatus 1102. The apparatus 1102 may be a UE or a component of a UE and includes a cellular baseband processor 1104 (also referred to as a modem) coupled to a cellular RF transceiver 1122. In some aspects, the apparatus may be associated with a vehicle, and may be referred to as a vehicle UE. The apparatus 1102 may include one or more subscriber identity modules (SIM) cards 1120. The apparatus may further include any of an application processor 1106 coupled to a secure digital (SD) card 1108 and a screen 1110, a Bluetooth module 1111, a wireless local area network (WLAN) module 1114, a Global Positioning System (GPS) module 1116, and/or a power supply 1118. The cellular baseband processor 1104 communicates through the cellular RF transceiver 1122 with the UE 104 and/or BS 102/180. The cellular baseband processor 1104 may include a computer-readable storage medium/memory. The computer-readable storage medium/memory may be non-transitory. The cellular baseband processor 1104 is responsible for general processing, including the execution of software stored on the computer-readable storage medium/memory. The software, when executed by the cellular baseband processor 1104, causes the cellular baseband processor 1104 to perform the various functions described supra. The computer-readable storage medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable storage medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the additional modules of the apparatus 1102.

The communication manager 1132 may include a connection component 1142 that is configured to establish a connection session with the first UE, e.g., as described in connection with 1002 in FIG. 10. The communication manager 1132 may further include an RRC controlee component 1144 that is configured to provide, to the first UE, a direct RRC connection with the radio access network via the connection session, e.g., as described in connection with 1004 in FIG. 10. The communication manager 1132 may further include a capability indication component 1146 that is configured to transmit a capability indication for the UE to the first UE, e.g., as described in connection with 1006 in FIG. 10. The communication manager 1132 may further include a configuration reception component 1148 that is configured to receive a configuration of a radio bearer of the second UE from the first UE, e.g., as described in connection with 1008 in FIG. 10. The communication manager 1132 may further include an RB component 1150 that is configured to establish, under the control of the first UE, one or more radio bearers of the second UE with the radio access network for a PDU session, e.g., as described in connection with 1010 in FIG. 10.

The apparatus may include additional components that perform each of the blocks of the algorithm in the flowchart of FIG. 10. As such, each block in the flowcharts of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable storage medium for implementation by a processor, or some combination thereof.

In some aspects, the apparatus 1102 may be a second UE that provides connection for a first UE (such as the UE 104) connected to a radio access network via the second UE. In one configuration, the apparatus 1102, and in particular the cellular baseband processor 1104, includes means for establishing a connection session with the first UE, such as the cellular RF transceiver 1122 or Bluetooth 1111. The cellular baseband processor 1104 may further include means for providing, to the first UE, a direct RRC connection with the radio access network via the connection session, such as the cellular RF transceiver 1122 or Bluetooth 1111. The cellular baseband processor 1104 may further include means for receiving a configuration of a radio bearer of the second UE from the first UE, such as the cellular RF transceiver 1122 or Bluetooth 1111. The cellular baseband processor 1104 may further include means for transmitting a capability indication to the first UE, such as the cellular RF transceiver 1122 or Bluetooth 1111. The cellular baseband processor 1104 may further include means for establishing, under the control of the first UE, one or more radio bearers of the second UE with the radio access network for a PDU session, such as the cellular RF transceiver 1122 or Bluetooth 1111.

The means may be one or more of the components of the apparatus 1102 configured to perform the functions recited by the means. As described supra, the apparatus 1102 may include the TX Processor 368, the RX Processor 356, and the controller/processor 359. As such, in one configuration, the means may be the TX Processor 368, the RX Processor 356, and the controller/processor 359 configured to perform the functions recited by the means.

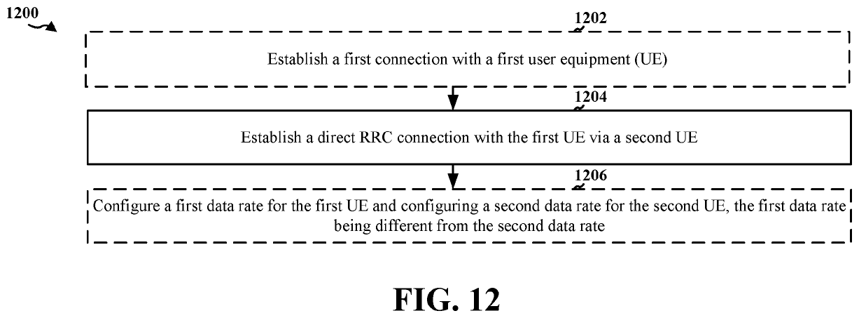

FIG. 12 is a flowchart 1200 of a method of wireless communication. The method may be performed by a network (e.g., the base station 102/180, the base station 704, the core network 502, the apparatus 1302. Optional steps are illustrated in dashed lines. The steps are not necessarily illustrated in chronological order. The method may enable improved wireless communication with one UE in a way that enables use of the UE's modem and RF components of another UE, such as a vehicle UE.

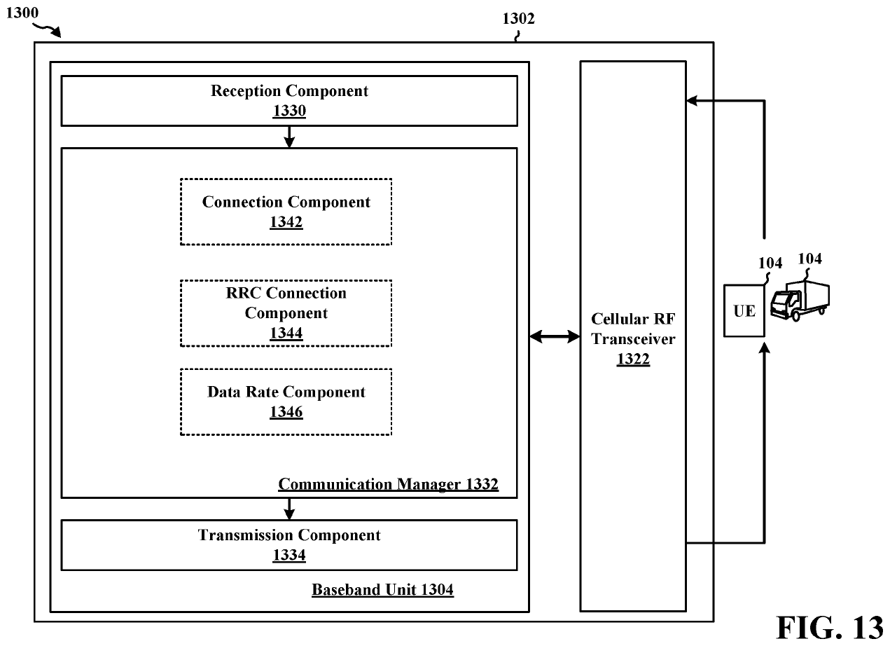

At 1202, the base station may establish a first connection with a first UE. In some aspects, 1202 may be performed by the connection component 1342 in FIG. 13. In some aspects, the first connection may correspond with the RRC connection 708 in FIG. 7 in FIG. 7. In some aspects, the first UE may correspond with the UE 702A in FIG. 7.

At 1204, the base station may establish a direct RRC connection with the first UE via a second UE. In some aspects, 1202 may be performed by the RRC connection component 1344 in FIG. 13. In some aspects, the RRC connection may correspond with the RRC connection 708 in FIG. 7. In some aspects, the second UE may correspond with the UE 702B in FIG. 7.

In some aspects, at 1206, the base station may configure a first data rate for the first UE and configuring a second data rate for the second UE, the first data rate being different from the second data rate. In some aspects, the base station may receive, from the first UE via the second UE, an indication indicating the data rates being different or an indication indicating the data rates.

FIG. 13 is a diagram 1300 illustrating an example of a hardware implementation for an apparatus 1302. The apparatus 1302 is a network apparatus and includes a baseband unit 1304. In some aspects, the apparatus 1302 may be a base station. The baseband unit 1304 may communicate through a cellular RF transceiver 1322 with the UE 104. The baseband unit 1304 may include a computer-readable storage medium/memory. The baseband unit 1304 is responsible for general processing, including the execution of software stored on the computer-readable storage medium/memory. The software, when executed by the baseband unit 1304, causes the baseband unit 1304 to perform the various functions described supra. The computer-readable storage medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. In some aspects, the components within the communication manager 1332 may be stored in the computer-readable storage medium/memory and/or configured as hardware within the baseband unit 1304. The baseband unit 1304 may be a component of the base station 310 and may include the memory 376 and/or at least one of the TX processor 316, the RX processor 370, and the controller/processor 375.

The communication manager 1332 may include a connection component 1342 that may be configured to establish a first connection with a first UE, e.g., as described in connection with 1202 in FIG. 12. The communication manager 1332 may further include an RRC connection component 1344 that may be configured to establish a direct RRC connection with the first UE via a second UE, e.g., as described in connection with 1204 in FIG. 12. The communication manager 1332 may further include a data rate component 1346 that may be configured to configure a first data rate for the first UE and configuring a second data rate for the second UE, the first data rate being different from the second data rate, e.g., as described in connection with 1206 in FIG. 12.

The apparatus may include additional components that perform each of the blocks of the algorithm in the flowchart of FIG. 12. As such, each block in the flowchart of FIG. 12 may be performed by a component and the apparatus may include one or more of those components. The components may be one or more hardware components specifically configured to carry out the stated processes/algorithm, implemented by a processor configured to perform the stated processes/algorithm, stored within a computer-readable storage medium for implementation by a processor, or some combination thereof.

In one configuration, the apparatus 1302, and in particular the baseband unit 1304, includes means for establishing a first connection with a first UE, such as the cellular RF transceiver 1322. The baseband unit 1304 may further include means for establishing a direct RRC connection with the first UE via a second UE, such as the cellular RF transceiver 1322. The baseband unit 1304 may further include means for configuring a first data rate for the first UE and configuring a second data rate for the second UE, the first data rate being different from the second data rate.

The means may be one or more of the components of the apparatus 1302 configured to perform the functions recited by the means. As described supra, the apparatus 1302 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a first UE, comprising: establishing a connection session with a second UE; establishing a direct RRC connection with a radio access network via the connection session; and configuring a radio bearer of the second UE.

Aspect 2 is the method of aspect 1, wherein configuring the radio bearer of the second UE comprises configuring the radio bearer of the second UE based on the RRC configuration received from the direct RRC connection from the radio access network.

Aspect 3 is the method of any of aspects 1-2, further comprising: configuring the second UE with a connection session profile that results RRC by the first UE.

Aspect 4 is the method of any of aspects 1-3, wherein configuring the second UE with the connection session profile further comprises receiving a capability indication from the second UE.

Aspect 5 is the method of any of aspects 1-4, wherein the connection session comprises a Bluetooth session.

Aspect 6 is the method of any of aspects 1-5, further comprising: controlling the second UE to establish one or more radio bearers of the second UE with the radio access network for a PDU session; and establishing the one or more radio bearers of the first UE with the radio access network for the PDU session.

Aspect 7 is the method of any of aspects 1-6, further comprising: controlling one or more of a RLC, a MAC, or a PHY of the second UE.

Aspect 8 is the method of any of aspects 1-7, wherein the direct RRC connection is configured to be encapsulated in an RRC layer of the first UE and transferred over a PDCP component of the second UE.

Aspect 9 is the method of any of aspects 1-8, further comprising: controlling a cell selection or a PLMN selection of the second UE.

Aspect 10 is the method of any of aspects 1-9, wherein establishing the direct RRC connection with the radio access network further comprises transmitting a registration request.

Aspect 11 is the method of any of aspects 1-10, wherein the connection session comprises a WLAN session.

Aspect 12 is the method of any of aspects 1-11, wherein the WLAN session comprises GTP-U.

Aspect 13 is the method of any of aspects 1-12, wherein a connection between the first UE and the second UE provides a lower layer MAC and PHY disaggregation.

Aspect 14 is the method of any of aspects 1-13, wherein the first UE supports a first data rate and the second UE supports a second data rate, the first data rate being different from the second data rate.

Aspect 15 is the method of any of aspects 1-14, wherein the first UE is connected to the radio access network via a first set of SRBs and the second UE is connected to the radio access network via a second set of SRBs, the first set of SRBs being different from the second set of SRBs.

Aspect 16 is a method of wireless communication at a second UE, comprising: establishing a connection session with the first UE; providing, to the first UE, a direct RRC connection with the radio access network via the connection session; receiving a configuration of a radio bearer of the second UE from the first UE.

Aspect 17 is the method of aspect 16, further comprising: transmitting a capability indication for the second UE to the first UE.

Aspect 18 is the method of any of aspects 16-17, wherein the connection session comprises a Bluetooth session.

Aspect 19 is the method of any of aspects 16-18, further comprising: establishing, based on at least in part on controlling signal from the first UE, one or more radio bearers of the second UE with the radio access network for a PDU session.

Aspect 20 is the method of any of aspects 16-19, wherein the direct RRC connection is configured to be encapsulated in an RRC layer of the first UE and transferred over a PDCP component of the second UE.

Aspect 21 is the method of any of aspects 16-20, wherein providing a direct RRC connection to the first UE further comprises receiving a registration request.

Aspect 22 is the method of any of aspects 16-21, wherein the connection session comprises a WLAN session.

Aspect 23 is the method of any of aspects 16-22, wherein the WLAN session comprises GTP-U.

Aspect 24 is the method of any of aspects 16-23, wherein the connection between the first UE and the second UE provides a lower layer MAC and PHY disaggregation.

Aspect 25 is a method of wireless communication at a radio access network, comprising: establishing a first connection with a first UE; and establishing a direct RRC connection with the first UE via a second UE.

Aspect 26 is the method of aspect 25, wherein the direct RRC connection is configured to be encapsulated in an RRC layer of the first UE and transferred over a PDCP component of the second UE.

Aspect 27 is the method of any of aspects 25-26, wherein the first UE is connected to the radio access network via a first set of SRBs and the second UE is connected to the radio access network via a second set of SRBs, the first set of SRBs being different from the second set of SRBs.

Aspect 28 is the method of any of aspects 25-27, further comprising: configuring a first data rate for the first UE and configuring a second data rate for the second UE, the first data rate being different from the second data rate.

Aspect 29 is the method of any of aspects 25-28, wherein the direct RRC connection comprises transparent forwarding of an RRC message via the second UE.

Aspect 30 is an apparatus for wireless communication including at least one processor coupled to a memory and configured to implement a method as in any of aspects 1 to 15.

Aspect 31 is an apparatus for wireless communication including at least one processor coupled to a memory and configured to implement a method as in any of aspects 16 to 24.

Aspect 32 is an apparatus for wireless communication including at least one processor coupled to a memory and configured to implement a method as in any of aspects 25 to 29.

Aspect 33 is an apparatus for wireless communication including means for implementing a method as in any of aspects 1 to 15.

Aspect 34 is an apparatus for wireless communication including means for implementing a method as in any of aspects 16 to 24.

Aspect 35 is an apparatus for wireless communication including means for implementing a method as in any of aspects 25 to 29.

Aspect 36 is a computer-readable medium storing computer executable code, where the code when executed by a processor causes the processor to implement a method as in any of aspects 1 to 15.

Aspect 37 is a computer-readable medium storing computer executable code, where the code when executed by a processor causes the processor to implement a method as in any of aspects 16 to 24.

Aspect 38 is a computer-readable medium storing computer executable code, where the code when executed by a processor causes the processor to implement a method as in any of aspects 25 to 29.

What is claimed is:

1. A method of wireless communication at a first user equipment (UE), comprising:
establishing a connection session with a second UE;
establishing a direct radio resource control (RRC) connection with a radio access network via the connection session; and
configuring a radio bearer of the second UE.

2. The method of claim 1, wherein configuring the radio bearer of the second UE comprises configuring the radio bearer of the second UE based on the RRC configuration received from the direct RRC connection from the radio access network.

3. The method of claim 1, further comprising:
configuring the second UE with a connection session profile that results radio resources control (RRC) by the first UE.

4. The method of claim 3, wherein configuring the second UE with the connection session profile further comprises receiving a capability indication from the second UE.

5. The method of claim 1, wherein the connection session comprises a Bluetooth session.

6. The method of claim 1, further comprising:
controlling the second UE to establish one or more radio bearers of the second UE with the radio access network for a PDU session; and
establishing the one or more radio bearers of the first UE with the radio access network for the PDU session.

7. The method of claim 1, further comprising:
controlling one or more of a radio link control (RLC), a medium access control (MAC), or a physical layer (PHY) of the second UE.

8. The method of claim 7, wherein the direct RRC connection is configured to be encapsulated in an RRC layer of the first UE and transferred over a Packet Data Convergence Protocol (PDCP) component of the second UE.

9. The method of claim 1, further comprising:
controlling a cell selection or a public land mobile network (PLMN) selection of the second UE.

10. The method of claim 1, wherein establishing the direct RRC connection with the radio access network further comprises transmitting a registration request.

11. The method of claim 1, wherein the connection session comprises a wireless local area network (WLAN) session.

12. The method of claim 11, wherein the WLAN session comprises general packet radio service (GPRS) tunneling user plane (GTP-U).

13. The method of claim 1, wherein a connection between the first UE and the second UE provides a lower layer medium access control (MAC) and physical layer (PHY) disaggregation.

14. The method of claim 1, wherein the first UE supports a first data rate and the second UE supports a second data rate, the first data rate being different from the second data rate.

15. The method of claim 1, wherein the first UE is connected to the radio access network via a first set of signaling radio bearers (SRBs) and the second UE is connected to the radio access network via a second set of SRBs, the first set of SRBs being different from the second set of SRBs.

16. A method of wireless communication at a second user equipment (UE), comprising:
establishing a connection session with a first UE;
providing, to the first UE, a direct radio resource control (RRC) connection with a radio access network via the connection session;
receiving a configuration of a radio bearer of the second UE from the first UE.

17. The method of claim 16, further comprising:
transmitting a capability indication for the second UE to the first UE.

18. The method of claim 16, wherein the connection session comprises a Bluetooth session.

19. The method of claim 16, further comprising:
establishing, based on at least in part on controlling signal from the first UE, one or more radio bearers of the second UE with the radio access network for a PDU session.

20. The method of claim 16, wherein the direct RRC connection is configured to be encapsulated in an RRC layer of the first UE and transferred over a Packet Data Convergence Protocol (PDCP) component of the second UE.

21. The method of claim 16, wherein providing a direct RRC connection to the first UE further comprises receiving a registration request.

22. The method of claim 16, wherein the connection session comprises a wireless local area network (WLAN) session.

23. The method of claim 22, wherein the WLAN session comprises general packet radio service (GPRS) tunneling user plane (GTP-U).

24. The method of claim 16, wherein the connection between the first UE and the second UE provides a lower layer medium access control (MAC) and physical layer (PHY) disaggregation.

25. A method of wireless communication at a radio access network, comprising:
establishing a first connection with a first user equipment (UE); and
establishing a direct radio resource control (RRC) connection with the first UE via a second UE.

26. The method of claim 25, wherein the direct RRC connection is configured to be encapsulated in an RRC layer of the first UE and transferred over a Packet Data Convergence Protocol (PDCP) component of the second UE.

27. The method of claim 25, wherein the first UE is connected to the radio access network via a first set of signaling radio bearers (SRBs) and the second UE is connected to the radio access network via a second set of SRBs, the first set of SRBs being different from the second set of SRBs.

28. The method of claim 25, further comprising:
configuring a first data rate for the first UE and configuring a second data rate for the second UE, the first data rate being different from the second data rate.

29. The method of claim 25, wherein the direct RRC connection comprises transparent forwarding of an RRC message via the second UE.

30. An apparatus for wireless communication at a first user equipment (UE), comprising:
means for establishing a connection session with a second UE;
means for establishing a direct radio resource control (RRC) connection with a radio access network via the connection session; and
means for configuring a radio bearer of the second UE.
